(19) United States
(12) Patent Application Publication
(10) Pub. No.: US 2007/0245617 A1
(43) Pub. Date: Oct. 25, 2007

(54) Electronic multiple-use vermin trap and method

(76) Inventor: Ronald Henry Deibert, Calgary (CA)

Correspondence Address: ACIST MEDICAL SYSTEMS, INC., IP DEPT., 7905 FULLER ROAD, EDEN PRAIRIE, MN, 55344, US

(21) Appl. No.: 11/407,961

(22) Filed: Apr. 21, 2006

(51) Int. Cl. A01M 23/10; A01M 23/00; A01M 23/12

(52) U.S. Cl. 43/72; 43/58; 43/74

(57) ABSTRACT

A vermin trap apparatus and method. The trap comprises a rotatable path between the entrance and the bait, and sensor means adjacent the rotatable path for detecting vermin presence on the rotatable path. When a vermin detection signal is sent to control means, the control means cause the rotatable path to rotate, thereby dislodging the vermin and dropping the vermin into a containment region. The trap is preferably also provided with means for electrocuting the vermin, with spray means adjacent the rotatable path to disinfect and wet the vermin to enhance electrocution.

### FIELD OF THE INVENTION

The present invention relates to animal traps, and more particularly to electric vermin traps.

### BACKGROUND OF THE INVENTION

Native to central Asia, mice arrived in North America with settlers from Europe and other points. Rats arrived in similar fashion. The rodents spread across North America and are now found in every province (except Alberta, which is rat-free) and territory in Canada, and every state in the United States. This includes all major population areas.

Mice are considered among the most troublesome and economically damaging rodents in North America. Rats are also a very serious problem, but because the general population does not usually come into regular contact with rats, rats are not perceived to be as significant a problem as mice. However, both mice and rats are very adaptable and able to live in close association with humans; as such, both are termed “commensal” rodents. Mice are much more common in residences and structures than other common rodents, including shrews, voles and squirrels. The focus is on mice for purposes of the present application, but the present invention is equally relevant and applicable to rats and other pests. The term “vermin” is often used herein, and is used in a non-limiting sense, being merely representative of the great variety of rodents and other pests that someone skilled in the art would easily recognize as being proper targets of the trap and method taught herein.

Mice live in and around homes, farms, commercial establishments, in open fields and meadows. With the onset of cold weather each fall, mice move into structures in search of shelter and food. Mice can survive with little or no free water, although they will readily drink if water is available. They can obtain all the water they need from the food they eat. An absence of free water, or food with low moisture content in their environment, may reduce their breeding potential.

Mice have poor eyesight, relying on their hearing and highly developed senses of smell, taste, and touch. Mice breed year round, but when living outdoors, they usually breed in spring and fall. A female may have five to ten litters of four to eight young per year, and the gestation period is 18 to 21 days. A female is sexually mature at six to eight weeks of age. Mouse populations can, therefore, increase rapidly under good conditions, and the average mouse lives one to two years.

Rodents can transmit various diseases to humans, including salmonellosis (food poisoning), rickettsialpox, and lymphocytic choriomeningitis. Mice may carry leptospirosis, rat bite fever, tapeworms, and organisms that may cause ringworm (a fungal disease of the skin) in humans. As well, mice may carry hantavirus pulmonary syndrome (“Hantavirus”), which can be lethal to humans. In addition, rodents can chew through protective covering on wires, looking for nest material, and can cause major damage in commercial and industrial complexes. Accordingly, rodents should not be tolerated around schools, restaurants, food storage areas, warehouses, office buildings, dwellings or other areas where humans may come into contact with rodents or the organisms they carry. The Food and Agricultural Organization of the United Nations reported that between one-fifth and one-third of the world's total food supply never reaches the table due to losses from rodents.

Damage, to insulation inside walls and attics, quickly occurs when mice reach large populations in dwellings and commercial buildings. They may gnaw electrical wiring and create fire hazards or other malfunctions that are expensive to repair.

Various control methods are currently employed, with varying degrees of effectiveness. Poison baits are commonly employed, but they should never be used when there may be children or other animals present. Further, this method also suffers from the fact that mice usually return to their nest in an inaccessible location prior to death. Even if they do not return to their nest, mice perishing within walls or other inaccessible places within a dwelling or commercial building can cause secondary infestations of damaging insects that feed and breed upon the carcasses. Mice will also hoard or carry food to other locations; such hoarding of food is common, and it may result in amounts of poison bait being moved to places where it goes undetected and may be hazardous to non-target species. Non-toxic methods of rodent control are more effective and considerably more sanitary since rodents captured by these methods can be disposed of properly.

Trapping is one alternative method of controlling mice, but it requires labour, time and handling of any captured mice. One advantage is that it eliminates the problem of odours from decomposing carcasses and secondary infestations that may occur when poisoning is used. It also has the advantage of not relying on inherently hazardous rodenticides, it permits the user to view his or her success, and it allows for easier disposal of the mice. However, the success rate for traps varies widely and the method still requires the physical handling of mice, with all the inherent dangers of the diseases mentioned above being transmitted to humans—and particularly Hantavirus.

So-called “snap traps” are simple and inexpensive; however, the quality and effectiveness varies widely. Some poorly made snap traps will often break when they are triggered, are ineffective due to flaws, or are not sensitive enough to catch small or cautious mice.

An alternative to snap traps are glue boards, which catch mice by means of a pressure sensitive adhesive. When mice attempt to cross the glue board, they get stuck, much the same way that flypaper catches flies. A significant drawback to glue boards is that the mouse is not killed (but will die from starvation and dehydration if not attended) and must be killed and then disposed of. Because the mouse is not killed, many jurisdictions have banned glue boards.

Box traps work on the principle that mice readily enter small holes. The traps then hold the mice by means of one-way doors. More than one mouse may be caught by these traps, but because the mice are only caught and not killed, someone needs to check the traps frequently and release the captured mice. Of course, they will need to be released some distance from the dwelling or commercial building or they will simply re-enter. And, again, all the hazards are present of the mice transmitting the various diseases to the persons handling the trap.

Several styles of electrocution traps have become available in recent years. Most are powered by batteries and produce death to rodents by delivering a high volt-low amperage jolt. These traps potentially offer a quick, easy and less messy means of removing rodents when compared to either snap traps or glue boards. However, their reliability varies greatly and there are reports that some rodents are capable of escaping lethal encounters with some models. All of them presently require someone to physically handle the dead rodents to dispose of them. Again, the possibility of disease being transmitted from the dead rodents is present.

What is needed, therefore, is a trap that is simple and effective, attracting vermin and providing for safe handling of the captured target, whether a live catch situation or otherwise.

### SUMMARY OF THE INVENTION

The present invention accordingly seeks to provide a trap and trapping method that is applicable to a number of rodent and pest types, which is simple, effective, and safe to use.

Traps according to the present invention may be either live traps or, preferably, electrocution traps. The present invention seeks to overcome and eliminate perceived inadequacies of traps currently on the market, as well as one significant deficiency in all traps—the need for human handling of a rodent, either dead or alive. In addition, the preferred electrocution embodiment of the present invention has been specifically designed to seek to eliminate the possibility of a rodent being able to avoid electrocution. Further, when utilizing bait having a scent, the use of a small fan in one preferred embodiment helps to ensure the bait odour is more widely dispersed than simply relying on existing air currents, therefore significantly improving the success ratio. Finally, where the rodent is electrocuted, it preferably drops into a disposal or containment chamber in which a liner (which may be a simple plastic bag) is placed; all that would then be required is for a drawer to be pulled out, and, as the drawer is being pulled out, the top of the liner can simply be folded over and closed, thereby sealing in the dead rodent, ready for immediate disposal.

According to a first aspect of the present invention, then, there is provided a vermin trap apparatus comprising:
a housing;
ingress means in the housing to enable vermin access to housing interior;
bait retention means at a location in the housing interior spaced from the ingress means, the bait retention means for receiving bait, the bait for attracting the vermin;
rotatable path means between the ingress means and the bait retention means;
a containment region disposed below the rotatable path means;
sensor means adjacent the rotatable path means for detecting vermin presence on the rotatable path means and sending a vermin detection signal to control means upon detecting vermin presence; and
the control means for rotating the rotatable path means in response to receiving the vermin detection signal, thereby dislodging the vermin and dropping the vermin into the containment region.

In exemplary embodiments of the first aspect, the apparatus further comprises an electrified platform disposed beneath the rotatable path means and above the containment region, such that contact with the electrified platform electrocutes the vermin before the vermin drops into the containment region. The electrified platform most preferably comprises a pair of electrified plates, angled downwardly toward the containment region, at least one of the electrified plates being pivotable to enable dropping of the vermin into the containment region after electrocution. The electrified platform may be selectively electrified, and the control means are then for selectively electrifying the electrified platform. Where the electrified platform comprises electrified plates, the electrified plates are selectively electrified, and the control means are then for selectively electrifying the electrified plates and for pivoting at least one of the electrified plates.

The rotatable path means preferably comprise a dowel extending at least partially across the housing interior, the dowel axially rotatable.

The sensor means preferably comprise a proximity sensor mounted on an interior surface of the housing, and the control means may be either directly wired to the sensor means or communicate with the sensor means by remote communication means.

An apparatus according to the first aspect may also further comprise spray means adjacent the rotatable path means for assisting in dislodging the vermin, the control means then for selectively activating the spray means in response to receiving the vermin detection signal. The spray means also dampen the vermin to facilitate electrocution.

The ingress means preferably comprise an aperture in the housing communicating with a tubular path, the tubular path leading to the rotatable path means.

An apparatus according to the first aspect preferably further comprises a fan adjacent the bait retention means, for propelling bait scent toward the ingress means, and the bait retention means are preferably separated from the rotatable path means by a partition, the fan disposed within the partition.

An apparatus according to the first aspect wherein electrocution is employed, preferably further comprises a removable liner within the containment region, for receiving vermin carcasses after electrocution and enabling disposal of the vermin carcasses. The apparatus also preferably further comprises a removable panel in the housing for allowing removal and disposal of vermin carcasses, and most preferably then further comprises deactivation means for deactivating electrification of the apparatus when the removable panel is removed.

As an apparatus according to the first aspect may require the control means to perform functions relating to the electrifying of the electrified platform and the rotating of the rotatable path means, the control means then would preferably comprise timer means for enabling staged activation of the electrifying of the electrified platform and the rotating of the rotatable path means. Where the control means are intended to also perform functions relating to the spray means activation, the control means would then preferably comprise timer means for enabling staged activation of the electrifying of the electrified platform, the activating of the spray means, and the rotating of the rotatable path means.

According to a second aspect of the present invention there is provided a vermin trap apparatus comprising:
a housing having an interior;
an aperture in the housing communicating with a tubular path in the housing interior;
bait retention means at a location in the housing interior spaced from the tubular path, the bait retention means for receiving bait, the bait for attracting the vermin;
a fan adjacent the bait retention means, for propelling bait scent toward the tubular path and the aperture;
a rotatable cylindrical member between the tubular path and the bait retention means, extending at least partially across the housing interior, the bait retention means separated from the rotatable cylindrical member by a partition, the fan disposed within the partition;
a containment region disposed below the rotatable cylindrical member, comprising a removable liner;
a pair of electrified plates disposed beneath the rotatable cylindrical member and above the containment region, angled downwardly toward the containment region, such that contact with the electrified plates electrocutes the vermin before the vermin drops into the containment region, at least one of the electrified plates being pivotable to enable dropping of the vermin into the containment region after electrocution;
spray means adjacent the rotatable cylindrical member for assisting in dislodging the vermin and dampening the vermin to facilitate electrocution;
a proximity sensor mounted on an interior surface of the housing adjacent the rotatable cylindrical member for detecting vermin presence on the rotatable cylindrical member and sending a vermin detection signal to control means upon detecting vermin presence;
the control means comprising timer means for enabling staged activation of:
   selectively electrifying the electrified plates in response to receiving the vermin detection signal;
   selectively activating the spray means in response to receiving the vermin detection signal;
   selectively rotating the rotatable cylindrical member in response to receiving the vermin detection signal, thereby dislodging the vermin and dropping the vermin onto the electrified plates for electrocution; and
   selectively pivoting the at least one of the electrified plates to enable dropping of the vermin into the containment region after electrocution;
the housing comprising a removable panel for allowing removal and disposal of vermin carcasses; and
deactivation means for deactivating electrification of the apparatus when the removable panel is removed.

According to a third aspect of the present invention there is provided a method for entrapping vermin comprising the steps of:
a. attracting the vermin to a trap using bait within the trap;
b. allowing the vermin to enter the trap;
c. providing rotatable path means within the trap;
d. allowing the vermin to proceed onto the rotatable path means;
e. sensing the vermin presence using sensor means;
f. sending a vermin detection signal from the sensor means to control means upon sensing the vermin presence;
g. sending a rotation signal from the control means to the rotatable path means; and
h. allowing the rotatable path means to rotate, dislodging the vermin and dropping the vermin into a containment region within the trap.

In exemplary embodiments of the third aspect, the method preferably comprising a further step before step d. of providing a tubular path leading to the rotatable path means, and a further step of allowing the vermin to proceed through the tubular path toward the rotatable path means. Where the sensor means comprise a proximity sensor, the method preferably comprises the further step after step d. and before step e. of allowing the vermin to enter proximity with the proximity sensor.

Where it is desired to practice a method which results in electrocution of the vermin, the method preferably comprises the further step of providing an electrified platform beneath the rotatable path means, and the further step of allowing the vermin to drop onto the electrified platform for electrocution before dropping the vermin into the containment region. The electrified platform most preferably comprises a pair of electrified plates, angled downwardly toward the containment region, at least one of the electrified plates being pivotable to enable dropping of the vermin into the containment region after electrocution, wherein the method comprises the further step of pivoting the pivotable electric plate or plates to enable dropping the vermin into the containment region. The electrified platform is preferably selectively electrified by means of the control means, wherein the method then comprises the further step before step h. of selectively electrifying the electrified platform upon receipt of the vermin detection signal. If it is desired to enhance electrocution by dampening the vermin, the trap further comprises spray means adjacent the rotatable path means, and the method then preferably comprises the further step after step f. and before step g. of activating the spray means upon receipt of the vermin detection signal, and the further step of allowing the spray means to spray the vermin.

In some preferred embodiments of this third aspect, the method comprises the further step of providing the containment region with a removable liner, and the step after step h. of disposing of the removable liner and contents. Where it is desired to provide a removable liner, the method most preferably comprises the further step of providing deactivation means to deactivate electrification of the apparatus, and the further step of using the deactivation means to deactivate electrification of the apparatus before disposing of the removable liner and contents.

Where it is desired that the control means should perform a variety of staged functions, the method then preferably comprises the further step before step g. of providing timer means in the control means for enabling staged activation of the selective electrifying of the electrified platform, the activating of the spray means (if desired), and the rotating of the rotatable path means.

According to a fourth aspect of the present invention there is provided a method for entrapping vermin comprising the steps of:
a. attracting the vermin to a trap using bait within the trap;
b. allowing the vermin to enter the trap;
c. providing rotatable path means within the trap;
d. providing an electrified platform beneath the rotatable path means, the electrified platform comprising a pair of electrified plates, angled downwardly toward a containment region within the trap, at least one of the electrified plates being pivotable;
e. providing the containment region with a removable liner;
f. providing deactivation means to deactivate electrification of the apparatus;
g. providing spray means adjacent the rotatable path means;
h. providing a tubular path leading to the rotatable path means;
i. allowing the vermin to proceed through the tubular path toward the rotatable path means;
j. allowing the vermin to proceed onto the rotatable path means;
k. sensing the vermin presence using sensor means;
l. sending a vermin detection signal from the sensor means to control means upon sensing the vermin presence;
m. providing timer means in the control means for enabling staged activation of selective electrifying of the electrified platform, activating of the spray means, and rotating of the rotatable path means;
n. selectively electrifying the electrified platform upon receipt by the control means of the vermin detection signal;
o. activating the spray means upon receipt by the control means of the vermin detection signal;
p. allowing the spray means to spray the vermin;
q. sending a rotation signal from the control means to the rotatable path means;
r. allowing the rotatable path means to rotate, dislodging the vermin and dropping the vermin;
s. allowing the vermin to drop onto the electrified platform for electrocution;
t. electrocuting the vermin;
u. pivoting the at least one of the electric plates to enable dropping the vermin into the containment region;
v. allowing the vermin to drop into the containment region;
w. using the deactivation means to deactivate electrification of the apparatus before extracting the removable liner and contents; and
x. extracting and disposing of the removable liner and contents.

As can therefore be clearly seen, there are a number of advantages over known traps and methods. The unique rotatable path (which may be a simple dowel) that the rodent must travel to approach the bait can ensure that the rodent cannot stray from the path, and the path undergoes a controlled rotation which ensures that the rodent loses its footing and falls to the preferably electrified plates below. In addition, the containment chamber is preferably lined with a plastic bag for containing the electrocuted rodent, thereby reducing human exposure to the various diseases outlined above. The present invention is therefore safer from a health perspective, and can be practiced in such a way as to ensure that there will be no direct contact with the rodent or any surfaces with which the rodent has come in contact. In addition, the preferred electrocution embodiment of the present invention, which is described in detail below, includes a disinfectant spray that both disinfects and assures greater electrical conductivity by dampening the rodent. Also, the electrified plates are preferably activated at the same time as the control means activate the spray pump, ensuring the plates are charged prior to the rodent falling.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate an exemplary embodiment of the present invention:

FIG. 1 is a schematic perspective view of an exemplary embodiment of the present invention, partially cut away;

FIG. 2 is a schematic perspective view showing the relative positioning of the spring-loaded solenoids for operation of the rotatable path means and the hinged electrified plate;

FIG. 3 is a schematic perspective view illustrating the positioning of the spray means;

FIG. 4 is a schematic perspective view further illustrating the exemplary embodiment;

FIG. 5 is a perspective view of the panel for housing the control electronics; and

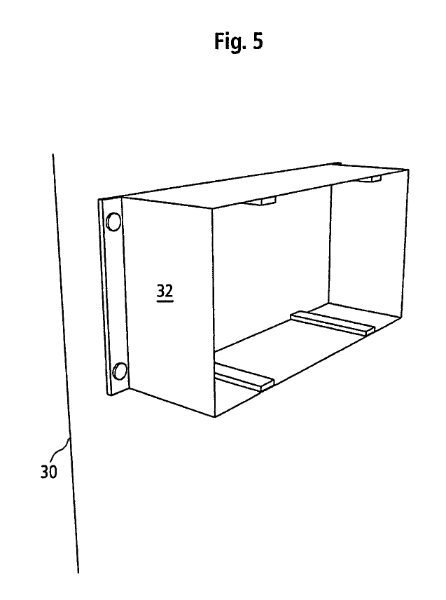

FIG. 6 is a simplified schematic illustrating the control electronics.

### DETAILED DESCRIPTION OF EXEMPLARY EMBODIMENT

Referring now in detail to the accompanying drawings, there is illustrated an exemplary embodiment of an electronic multiple-use trap according to the present invention, generally referred to by the numeral 31. The exemplary embodiment illustrates an electrocution style of trap, but the present invention could easily be practiced as a live-catch trap.

The purpose of the exemplary embodiment of the present invention is to attract rodents and/or pests to a self-contained automated system that efficiently and humanely kills them and eliminates the need for humans to directly handle the carcasses when disposing of them. This system eliminates direct contact with humans by utilizing disinfectants and sanitary containment for disposal. The self-contained unit is appropriately sized to conform to the physical characteristics of the rodent and/or pest that is the subject.

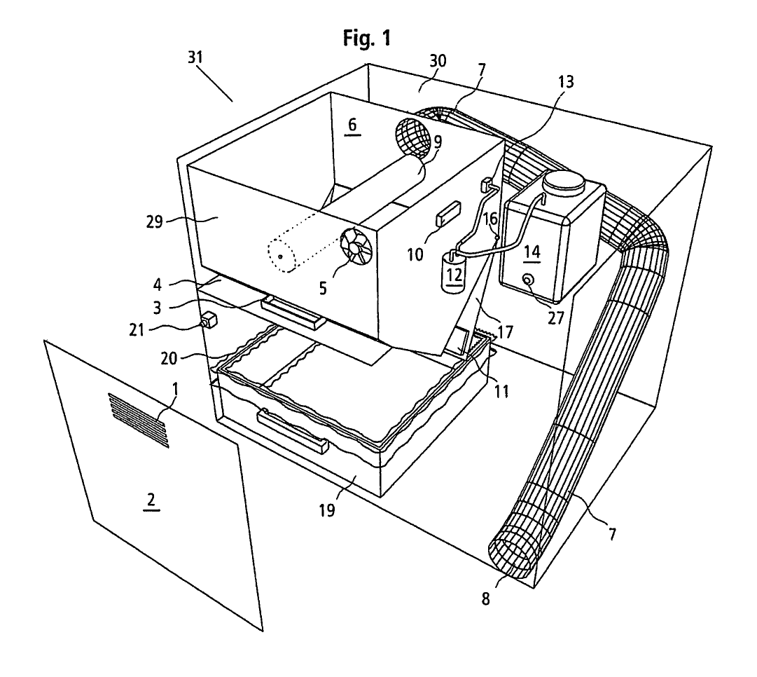

Referring now to FIG. 1, an exemplary trap 31 is illustrated comprising a housing 30 (which is cut away at top and front to expose the trap 31 contents), an opening 8 for allowing vermin (not shown) to enter the housing 30, a tunnel 7 for guiding the vermin toward bait 3 disposed on a bait tray 4, and a fan 5 disposed in a partition 29 for attracting the vermin into the trap 31. Air is drawn through vents 1 (which are provided in a removable access door 2, discussed below) on the front of the housing 30 by means of the fan 5, which air flows over the odorous bait 3 and is forced through the tunnel 7 (as the activation chamber 6 is enclosed) and out the opening 8 to attract the target vermin. The fan 5 ensures that the scent of the bait 3 is transmitted over a larger area than if only the usual air currents were relied upon. Rodents and pests are attracted to the opening 8 by the smell of the bait 3, but they never actually reach the bait 3 due to the rotatable path means (discussed below).

When the vermin enters the tunnel 7, it follows the scent up into the activation chamber 6 and proceeds out onto the upper surface of the rotatable path means, which in this exemplary embodiment is a simple wooden dowel 9. Upon the vermin reaching a certain point along the dowel 9, which in the illustrated embodiment is approximately half-way across the dowel 9, the vermin's presence would be detected by a sensor 10, which could be a common proximity sensor well known to those skilled in the art.

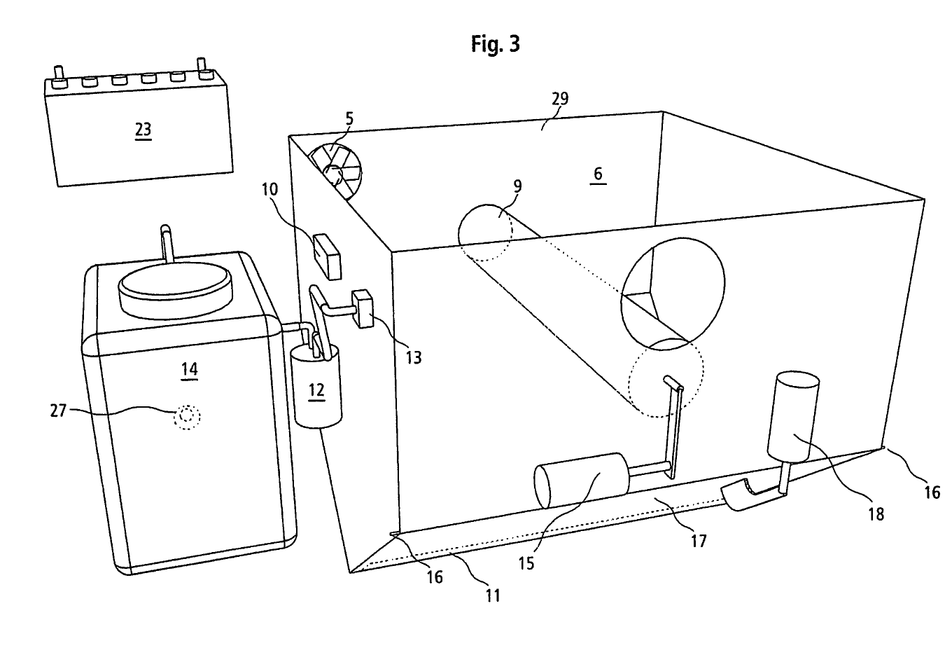

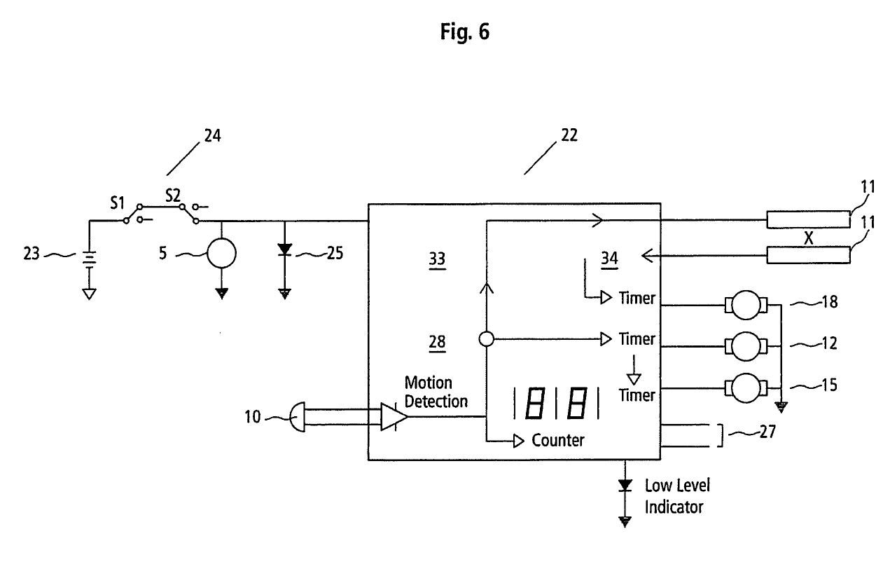

The trap 31 is powered by a battery 23, as can be seen in FIGS. 3 and 6, with switches 24 to control feed of power to the fan 5 and, passing through a power indicator 25, the control electronics 22 (which are housed in an electronics housing 32, which mates with the trap housing 30). The sensor 10 sends a signal which initiates a series of actions within the trap 31. The signal is sent to the control electronics 22, which are illustrated in simplified form in FIG. 6. A main timer 28 and associated timers control a staged series of events, as would be obvious to one skilled in the art. First, the timer 28 allows for power to flow through a DC to AC converter 33, as can be seen in FIG. 6, which activates the electrifying of electrified plates 11 in the trap 31; the activation can be pre-set to remain active for a set period of time sufficient in the judgment of a skilled person for electrocution purposes.

At the same time, or immediately after activation of the plates 11, the timer 28 enables power to flow and activate a pump 12 for a pre-set duration to produce a burst of spray (not shown) from a sprayer 13, preferably from the side and slightly behind the rodent. The spray liquid is stored in a reservoir 14, and it is a disinfectant (ensuring safer conditions for humans) which also, through wetting the rodent, enhances electrocution of the rodent.

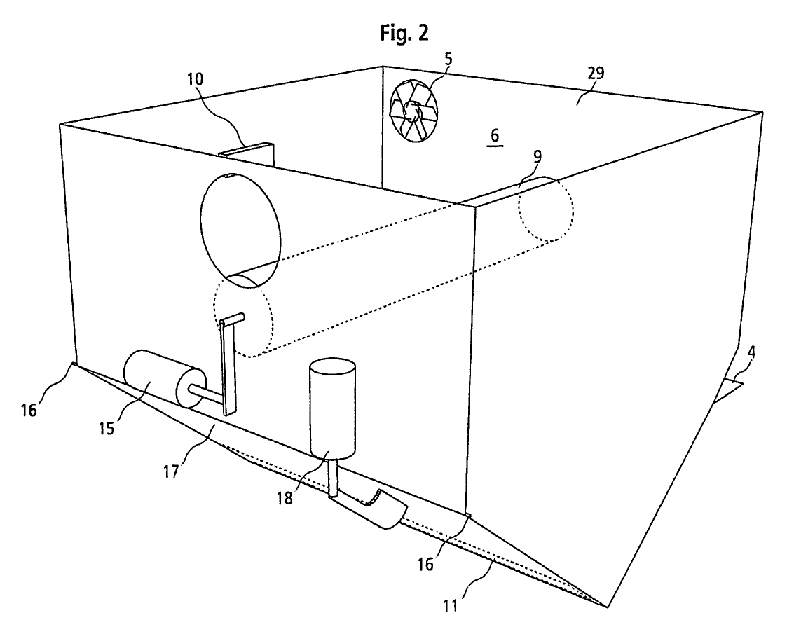

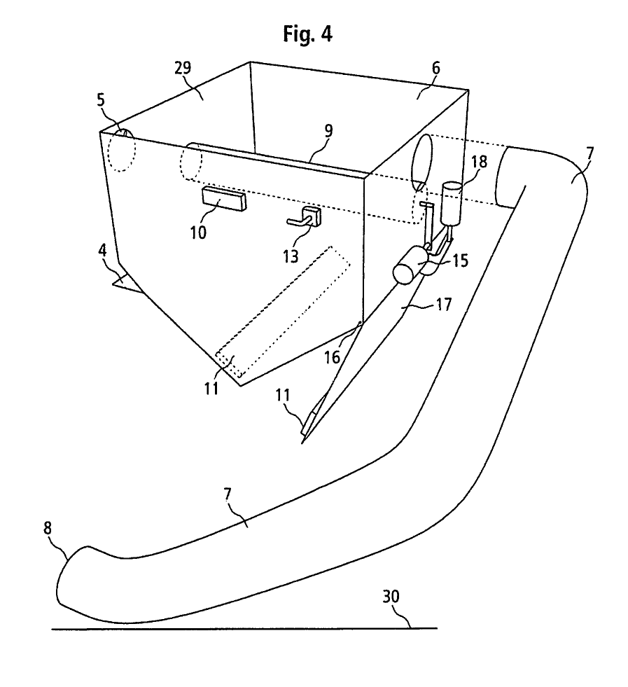

Next, the timer 28 activates a first spring-loaded solenoid 15, which can be seen in FIGS. 2, 3 and 4. The solenoid 15 rotates the dowel 9, preferably with a sharp, quarter-turn jerking motion; this, combined with the startling spray, causes the rodent to lose its footing on the dowel 9 and fall downwards toward the electrified plates 11.

The electrified plates 11 are disposed on opposing sides of a V-shaped hopper at the bottom of the activation chamber 6. When the rodent falls from the dowel 9, it makes contact with the electrified plates 11 and experiences electrocution, as the current flows from one plate 11 to the other through the body of the rodent. The current and duration can be pre-set to ensure immediate electrocution.

One side of the hopper bottom is fixed, while the other side 17 can pivot at a hinge 16. Load detection means 34 activate the timer for a second spring-operated solenoid 18. When sufficient current draw is detected by the load detection means 34, a signal is sent to the solenoid 18 which allows the hopper bottom 17 to pivot at the hinge 16, releasing the now-dead rodent and dropping same into a containment drawer 19. The containment drawer 19 is lined with a plastic bag 20, which bag is suitable for sanitary disposal of the dead rodent and also catches any residual spray from the sprayer 13. The removable access door 2 is opened, the drawer 19 is pulled out, the bag 20 is closed, and disposal may continue. The bag 20 may be sized to contain multiple pest carcasses, as would be obvious to one skilled in the art. The bag 20 can then be replaced, and the bait 3 if necessary, and the trap 31 is then re-set.

The access door 2 is also preferably provided with a limit switch 21, which can disable the power to the trap 31 when the access door 2 is opened to allow for disposal of the rodent carcasses. The reservoir 14 is also preferably provided with level sensing means 27, comprising a level sensor and low-level indicator.

Because the rodent and/or pest was originally sprayed with disinfectant, the health risk to humans is significantly reduced. Further, because humans do not need to directly come in contact with the dead rodent and/or pest, the health risk is further reduced.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

Embodiments of the invention in which an exclusive property or privilege is claimed are defined as follows:

1. A vermin trap apparatus comprising:
a housing;
ingress means in the housing to enable vermin access to housing interior;
bait retention means at a location in the housing interior spaced from the ingress means, the bait retention means for receiving bait, the bait for attracting the vermin;
rotatable path means between the ingress means and the bait retention means;
a containment region disposed below the rotatable path means;
sensor means adjacent the rotatable path means for detecting vermin presence on the rotatable path means and sending a vermin detection signal to control means upon detecting vermin presence; and
the control means for rotating the rotatable path means in response to receiving the vermin detection signal, thereby dislodging the vermin and dropping the vermin into the containment region.

2. The apparatus of claim 1 further comprising an electrified platform disposed beneath the rotatable path means and above the containment region, such that contact with the electrified platform electrocutes the vermin before the vermin drops into the containment region.

3. The apparatus of claim 2 wherein the electrified platform comprises a pair of electrified plates, angled downwardly toward the containment region, at least one of the electrified plates being pivotable to enable dropping of the vermin into the containment region after electrocution.

4. The apparatus of claim 2 wherein the electrified platform is selectively electrified, and the control means are for selectively electrifying the electrified platform.

5. The apparatus of claim 3 wherein the electrified plates are selectively electrified, and the control means are for selectively electrifying the electrified plates and for pivoting the at least one of the electrified plates.

6. The apparatus of claim 1 further comprising spray means adjacent the rotatable path means for assisting in dislodging the vermin, the control means for selectively activating the spray means in response to receiving the vermin detection signal.

7. The apparatus of claim 2 further comprising spray means adjacent the rotatable path means for assisting in dislodging the vermin, the control means for selectively activating the spray means in response to receiving the vermin detection signal, wherein the spray means dampens the vermin to facilitate electrocution.

8. The apparatus of claim 1 wherein the ingress means comprise an aperture in the housing communicating with a tubular path, the tubular path leading to the rotatable path means.

9. The apparatus of claim 1 further comprising a fan adjacent the bait retention means, for propelling bait scent toward the ingress means.

10. The apparatus of claim 9 wherein the bait retention means are separated from the rotatable path means by a partition, the fan disposed within the partition.

11. The apparatus of claim 2 further comprising a removable liner within the containment region, for receiving vermin carcasses after electrocution and enabling disposal of the vermin carcasses.

12. The apparatus of claim 1 wherein the sensor means comprise a proximity sensor mounted on an interior surface of the housing.

13. The apparatus of claim 1 wherein the control means are directly wired to the sensor means.

14. The apparatus of claim 1 wherein the control means communicate with the sensor means by remote communication means.

15. The apparatus of claim 1 wherein the rotatable path means comprise a dowel extending at least partially across the housing interior, the dowel axially rotatable.

16. The apparatus of claim 4 further comprising a removable panel in the housing for allowing removal and disposal of vermin carcasses.

17. The apparatus of claim 16 further comprising deactivation means for deactivating electrification of the apparatus when the removable panel is removed.

18. The apparatus of claim 4 wherein the control means comprise timer means for enabling staged activation of the electrifying of the electrified platform and the rotating of the rotatable path means.

19. The apparatus of claim 6 wherein the control means comprise timer means for enabling staged activation of the electrifying of the electrified platform, the activating of the spray means, and the rotating of the rotatable path means.

20. A vermin trap apparatus comprising:
a housing having an interior;
an aperture in the housing communicating with a tubular path in the housing interior;
bait retention means at a location in the housing interior spaced from the tubular path, the bait retention means for receiving bait, the bait for attracting the vermin;
a fan adjacent the bait retention means, for propelling bait scent toward the tubular path and the aperture;
a rotatable cylindrical member between the tubular path and the bait retention means, extending at least partially across the housing interior, the bait retention means separated from the rotatable cylindrical member by a partition, the fan disposed within the partition;
a containment region disposed below the rotatable cylindrical member, comprising a removable liner;
a pair of electrified plates disposed beneath the rotatable cylindrical member and above the containment region, angled downwardly toward the containment region, such that contact with the electrified plates electrocutes the vermin before the vermin drops into the containment region, at least one of the electrified plates being pivotable to enable dropping of the vermin into the containment region after electrocution;
spray means adjacent the rotatable cylindrical member for assisting in dislodging the vermin and dampening the vermin to facilitate electrocution;
a proximity sensor mounted on an interior surface of the housing adjacent the rotatable cylindrical member for detecting vermin presence on the rotatable cylindrical member and sending a vermin detection signal to control means upon detecting vermin presence;
the control means comprising timer means for enabling staged activation of:
selectively electrifying the electrified plates in response to receiving the vermin detection signal;
selectively activating the spray means in response to receiving the vermin detection signal;
selectively rotating the rotatable cylindrical member in response to receiving the vermin detection signal, thereby dislodging the vermin and dropping the vermin onto the electrified plates for electrocution; and
selectively pivoting the at least one of the electrified plates to enable dropping of the vermin into the containment region after electrocution;
the housing comprising a removable panel for allowing removal and disposal of vermin carcasses; and
deactivation means for deactivating electrification of the apparatus when the removable panel is removed.

21. A method for entrapping vermin comprising the steps of:
a. attracting the vermin to a trap using bait within the trap;
b. allowing the vermin to enter the trap;
c. providing rotatable path means within the trap;
d. allowing the vermin to proceed onto the rotatable path means;
e. sensing the vermin presence using sensor means;
f. sending a vermin detection signal from the sensor means to control means upon sensing the vermin presence;
g. sending a rotation signal from the control means to the rotatable path means; and
h. allowing the rotatable path means to rotate, dislodging the vermin and dropping the vermin into a containment region within the trap.

22. The method of claim 21 comprising a further step before step d. of providing a tubular path leading to the rotatable path means, and a further step of allowing the vermin to proceed through the tubular path toward the rotatable path means.

23. The method of claim 21 wherein the sensor means comprise a proximity sensor, wherein the method comprises the further step after step d. and before step e. of allowing the vermin to enter proximity with the proximity sensor.

24. The method of claim 21 comprising the further step of providing an electrified platform beneath the rotatable path means, and the further step of allowing the vermin to drop onto the electrified platform for electrocution before dropping the vermin into the containment region.

25. The method of claim 24 wherein the electrified platform comprises a pair of electrified plates, angled downwardly toward the containment region, at least one of the electrified plates being pivotable to enable dropping of the vermin into the containment region after electrocution, wherein the method comprises the further step of pivoting the at least one of the electric plates to enable dropping the vermin into the containment region.

26. The method of claim 24 wherein the electrified platform is selectively electrified by means of the control means, wherein the method comprises the further step before step h. of selectively electrifying the electrified platform upon receipt of the vermin detection signal.

27. The method of claim 24 wherein the trap further comprises spray means adjacent the rotatable path means, the method comprising the further step after step f. and before step g. of activating the spray means upon receipt of the vermin detection signal, and the further step of allowing the spray means to spray the vermin.

28. The method of claim 24 comprising the further step of providing the containment region with a removable liner, and the step after step h. of disposing of the removable liner and contents.

29. The method of claim 28 comprising the further step of providing deactivation means to deactivate electrification of the apparatus, and the further step of using the deactivation means to deactivate electrification of the apparatus before disposing of the removable liner and contents.

30. The method of claim 26 comprising the further step before step g. of providing timer means in the control means for enabling staged activation of the selective electrifying of the electrified platform and the rotating of the rotatable path means.

31. The method of claim 27 comprising the further step before step g. of providing timer means in the control means for enabling staged activation of the selective electrifying of the electrified platform, the activating of the spray means, and the rotating of the rotatable path means.

32. A method for entrapping vermin comprising the steps of:
a. attracting the vermin to a trap using bait within the trap;
b. allowing the vermin to enter the trap;
c. providing rotatable path means within the trap;
d. providing an electrified platform beneath the rotatable path means, the electrified platform comprising a pair of electrified plates, angled downwardly toward a containment region within the trap, at least one of the electrified plates being pivotable;
e. providing the containment region with a removable liner;
f. providing deactivation means to deactivate electrification of the apparatus;
g. providing spray means adjacent the rotatable path means;
h. providing a tubular path leading to the rotatable path means;
i. allowing the vermin to proceed through the tubular path toward the rotatable path means;
j. allowing the vermin to proceed onto the rotatable path means;
k. sensing the vermin presence using sensor means;
l. sending a vermin detection signal from the sensor means to control means upon sensing the vermin presence;
m. providing timer means in the control means for enabling staged activation of selective electrifying of the electrified platform, activating of the spray means, and rotating of the rotatable path means;
n. selectively electrifying the electrified platform upon receipt by the control means of the vermin detection signal;
o. activating the spray means upon receipt by the control means of the vermin detection signal;
p. allowing the spray means to spray the vermin;
q. sending a rotation signal from the control means to the rotatable path means;
r. allowing the rotatable path means to rotate, dislodging the vermin and dropping the vermin;
s. allowing the vermin to drop onto the electrified platform for electrocution;
t. electrocuting the vermin;
u. pivoting the at least one of the electric plates to enable dropping the vermin into the containment region;
v. allowing the vermin to drop into the containment region;
w. using the deactivation means to deactivate electrification of the apparatus before extracting the removable liner and contents; and
x. extracting and disposing of the removable liner and contents.
